(19) United States
(12) Patent Application Publication
(10) Pub. No.: US 2021/0260631 A1
(43) Pub. Date: Aug. 26, 2021

(54) On-Line Equipment Cleaning Method

(71) Applicant: United Laboratories International, LLC, Houston, TX (US)

(72) Inventors: Stephen D. Matza, Sugar Land, TX (US); Colin Chambers, Houston, TX (US)

(73) Assignee: United Laboratories International, LLC, Houston, TX (US)

(21) Appl. No.: 17/022,237

(22) Filed: Sep. 16, 2020

Related U.S. Application Data
(60) Provisional application No. 62/979,360, filed on Feb. 20, 2020.

(51) Int. Cl. B08B 3/08; C11D 3/43; C11D 11/00

(52) U.S. Cl. CPC B08B 3/08; C11D 11/0041; C11D 3/43

(57) ABSTRACT

A method for decontaminating industrial facility equipment while the equipment remains in operation (i.e., on-line decontamination). In one embodiment, the method comprises reducing the total volumetric flowrate, injecting a decontamination composition into the industrial equipment at an injection point while the industrial equipment remains in operation, wherein the decontamination composition comprises a solvent composition and a carrier fluid, allowing the decontamination composition to come in contact with any contaminant material disposed on the industrial equipment, wherein the contact removes the contaminant material from the industrial equipment, and managing the contaminant material removed from the industrial equipment.

### CROSS-REFERENCE TO RELATED APPLICATIONS

This application is a Nonprovisional application which claims the benefit of U.S. Provisional Application Ser. No. 62/793,360 filed Feb. 20, 2020, the disclosure of which is incorporated by reference herein in its entirety.

### STATEMENT REGARDING FEDERALLY SPONSORED RESEARCH OR DEVELOPMENT

Not applicable.

### BACKGROUND OF THE INVENTION

### Field of the Invention

The present invention relates to the field of decontaminating industrial facility equipment, and more particularly to decontaminating industrial facility equipment while the equipment is in operation.

### Background of the Invention

Industrial facilities such as refineries and petrochemical facilities, utilize a variety of industrial equipment to process raw materials into useful products. Over time, contaminant materials such as, without limitation, asphalt, heavy asphaltenic materials, hydrogen-deficient carbonaceous materials, coke, tar, and the like may be produced as byproducts within the industrial equipment due to the types of fluids and/or gases being processed. Such contamination can hinder industrial equipment from operating at a maximum efficiency, which thereby can lead to negative economic impacts for a facility. In order for contaminated industrial equipment to regain maximum efficiency it must be cleaned and/or decontaminated. However, typical cleaning and decontamination processes require the industrial equipment be removed from the operation, thus hindering maximum efficiency of a facility. Once again, this can lead to negative economic impacts for an industrial facility. Currently, industrial facility operators are forced to decide between running contaminated industrial equipment at a low efficiency or stopping full production operations to clean contaminated equipment, both of which result in minimized efficiency.

Consequently, there is a need in the art for a system and method for decontaminating industrial equipment, while said equipment remains in operation.

### BRIEF SUMMARY OF SOME OF THE PREFERRED EMBODIMENTS

These and other needs in the art are addressed in one embodiment by a method for decontaminating industrial equipment in operation, wherein the industrial equipment comprises a total volumetric flowrate while operating, comprising reducing the total volumetric flowrate; injecting a decontamination composition into the industrial equipment at an injection point while the industrial equipment remains in operation, wherein the decontamination composition comprises a solvent composition and a carrier fluid; allowing the decontamination composition to come in contact with any contaminant material disposed on the industrial equipment, wherein the contact removes the contaminant material from the industrial equipment; and managing the contaminant material removed from the industrial equipment.

These and other needs in the art are addressed in one embodiment by a method for decontaminating industrial equipment in operation, wherein the industrial equipment comprises a total volumetric flowrate while operating, comprising reducing the total volumetric flowrate; injecting a decontamination composition into the industrial equipment at an injection point while the industrial equipment remains in operation, wherein the decontamination composition comprises a solvent composition and a carrier fluid; allowing the decontamination composition to come in contact with any contaminant material disposed on the industrial equipment, wherein the contact removes the contaminant material from the industrial equipment; heating the decontamination composition via a recycled stream of the industrial equipment; and managing the contaminant material removed from the industrial equipment.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### DETAILED DESCRIPTION OF THE PREFERRED EMBODIMENTS

In an embodiment, industrial equipment utilized by industrial facilities (e.g., oil refineries, natural gas processing plants, petrochemical facilities, port terminals, and the like) may be cleaned and/or decontaminated by injecting a decontamination composition through the industrial equipment such that the decontamination composition comes in contact with any contaminants disposed on the industrial equipment. The formulation of the decontamination composition may allow the industrial equipment to remain in operation while undergoing cleaning and/or decontamination.

In embodiments, the industrial equipment may comprise, without limitation, vessels, tanks, vacuum towers, piping, distillation columns, one or more heat exchangers, and various other treating and/or blending units. In embodiments, the industrial equipment may be configured such that various fluids and/or gases of the industrial facility may be fed through the one or more heat exchangers and then into the various treating and/or blending units. In these embodiments, the one or more heat exchangers may comprise, without limitation, shell and tube heat exchangers, plate heat exchangers, plate and shell heat exchangers, plate fin heat exchangers, or any combinations thereof. The various treating and/or blending units may comprise, without limitation, desalters, coker units, delayed coker units, fractionators, FCC units, hydrotreaters, diesel hydrotreaters, cracker units, hydrocrackers, crude distillation columns, vacuum distillation columns, fluidized catalytic crackers, visbreakers, or any combinations thereof. In embodiments, the industrial equipment (e.g., the one or more heat exchangers), may be difficult to clean and/or decontaminate due to its design. In particular, cleaning the industrial equipment while it remains in operation (i.e., on-line cleaning) may be especially difficult because an operator may be required to consider how the on-line cleaning may affect the industrial equipment and the various fluids and/or gases passing through the industrial equipment. Introduction of atypical elements to the industrial equipment may affect safety and reliability of the equipment or compromise the fluids and/or gases traveling through the equipment. For example, a hydrotreater may comprise a fixed-bed reactor catalyst that may be easily subjected to poisoning by coming in contact with certain elements such as, without limitation, nitrogen contents and/or metals. Further, atypical elements carried partially or fully throughout the processes performed by the industrial equipment, may impact product specification regulations. For example, the amount of sulfur that can be present in diesel fuel is regulated and limited and may be affected by the introduction of atypical elements. Similarly, jet fuel has certain water specifications that must be met and the introduction of a typical elements may inhibit this requirement. As such, on-line cleaning of industrial equipment may require a particular decontamination composition along with a particular on-line decontamination process in order to be successfully achieved.

In embodiments, the decontamination composition that allows for on-line cleaning of the industrial equipment may be the composition disclosed in U.S. Patent Application Publication No. 2016-0312160 A1 or U.S. Patent Application Publication No. 2015-0267152 A1, of which are incorporated herein by reference. The decontamination composition may comprise a solvent composition and a carrier fluid. The solvent composition may comprise a mixture of three solvents and a cationic surfactant. The first solvent may be methyl soyate. The second solvent may be an aprotic solvent (i.e., dimethyl sulfoxide). The third solvent may be any solvent suitable for maintaining the cationic surfactant in solution (e.g., alcohols, esters, ketones, and the like). Without limitation, the solvent composition may disaggregate and/or dissolve contaminant materials from the industrial equipment in the industrial facilities. In embodiments, contaminant materials to be removed may include any contaminant material produced, stored, transported, or the like during the process of crude oil refinement, natural gas processing, hydrocarbon transport, hydrocarbon processing, hydrocarbon cleanup, and the like. In embodiments, examples of contaminant materials include asphalt, heavy asphaltenic materials, hydrogen-deficient carbonaceous materials, coke, tar, heavy oil deposits, hydrocarbon sludge, lube oil, the like, or any combinations thereof. In embodiments, the contaminant materials are contacted with the solvent composition, such that the contaminant materials are disaggregated and/or dissolved and may then be subsequently removed from industrial equipment.

Embodiments of the solvent composition comprise the solvent methyl soyate (MESO). MESO is a biodegradable long-chain esterified fatty acid. The solvent composition may have any wt. % of MESO suitable for disaggregating and/or dissolving contaminant materials such that at least a portion of a contaminant material may be removed from industrial equipment. For instance, the contaminant material may be removed from the surface of industrial equipment. In an embodiment, the solvent composition has between about 20.0 wt. % MESO and about 40.0 wt. % MESO, alternatively between about 25.0 wt. % MESO and about 35.0 wt. % MESO. In some embodiments, the MESO may comprise about 30.0 wt. % of the solvent composition. With the benefit of this disclosure, one of ordinary skill in the art will be able to select an appropriate amount of MESO for a chosen application.

Embodiments of the solvent composition comprise an aprotic solvent. Aprotic solvents include any solvents that neither donate protons nor accept protons. Aprotic solvents include dimethyl sulfoxide (DMSO), N-methylpyrrolidone (NMP), dimethyl formamide, benzene, or any combinations thereof. In an embodiment, the aprotic solvent is DMSO. In embodiments, the aprotic solvent is DMSO and does not include any or substantially any NMP, benzene, and/or dimethyl formamide. The solvent composition may have any wt. % of aprotic solvent suitable for disaggregating and/or dissolving contaminant materials such that at least a portion of a contaminant material may be removed from industrial equipment. In an embodiment, the solvent composition has between about 20.0 wt. % aprotic solvent and about 50.0 wt. % aprotic solvent, alternatively between about 25.0 wt. % aprotic solvent and about 35.0 wt. % aprotic solvent. In some embodiments, the aprotic solvent may comprise about 32.0 wt. % of the solvent composition. With the benefit of this disclosure, one of ordinary skill in the art will be able to select an appropriate amount of aprotic solvent for a chosen application.

Embodiments of the solvent composition comprise a third solvent (TS). The third solvent may be any solvent, or combination of solvents, suitable for maintaining the cationic surfactant in solution and/or for lowering the surface tension of the solvent composition. Without limitation, the third solvent facilitates the contaminant material removal process. The TS may be an alcohol, an ester, ether, the like, or any combinations thereof. In some embodiments, the alcohol may include dipropylene glycol, propylene glycol, simple alcohols ranging from C₈ to C₁₈ (e.g., octanol, dodecanol), the like, or any combinations thereof. In some embodiments, the ester may include ethyl acetate, isobutyl acetate, glycol esters (e.g., glycol stearate, monoglycerides such as glyceryl stearate, and the like), the like, or any combinations thereof. In some embodiments, the ether may include a glycol such as dipropylene glycol, or an alkyl glucoside such as decyl glucoside, the like or any combinations thereof. In an embodiment, the TS is dipropylene glycol. In some embodiments, the TS, in addition to maintaining the cationic surfactant in solution, possesses a high boiling point, low toxicity, biodegradability, or any combinations thereof. The solvent composition may have any wt. % of the TS suitable for maintaining the cationic surfactant in solution and/or lowering the surface tension of the solvent composition, which without limitation facilitates the contaminant removal process. In an embodiment, the solvent composition has between about 20.0 wt. % TS and about 40.0 wt. % TS, alternatively between about 25.0 wt. % TS and about 35.0 wt. % TS. In some embodiments, the TS may comprise about 30.0 wt. % of the solvent composition. With the benefit of this disclosure, one of ordinary skill in the art will be able to select an appropriate amount of the TS for a chosen application.

Embodiments of the solvent composition comprise a cationic surfactant. The cationic surfactant may be any cationic surfactant or combination of cationic surfactants suitable for use in the solvent composition. The cationic surfactant may be a quaternary ammonium salt such as an imidazole derivative. Without limitation, specific examples of the cationic surfactant include heterocycles (e.g., isostearyl ethylimidazolinium ethosulfate (ISES), and the like), alkyl-substituted pyridines, morpholinium salts, alkyl ammonium salts (e.g., cetyl trimethylammonium bromide, stearalkonium chloride, dimethyldioctadecylammonim chloride, and the like), the like, or any combinations thereof. In an embodiment, the cationic surfactant is ISES. The solvent composition may have any wt. % of the cationic surfactant for disaggregating and/or dissolving contaminant materials such that at least a portion of a contaminant material may be removed from industrial equipment. In some embodiments, the cationic surfactant may have detergent properties such as disaggregation and emulsification. In an embodiment, the solvent composition has between about 4.0 wt. % cationic surfactant and about 12.0 wt. % cationic surfactant, alternatively between about 6.0 wt. % cationic surfactant and about 10.0 wt. % cationic surfactant. In some embodiments, the cationic surfactant may comprise about 8.0 wt. % of the solvent composition. With the benefit of this disclosure, one of ordinary skill in the art will be able to select an appropriate amount of cationic surfactant for a chosen application.

In optional embodiments, the solvent composition may comprise a dispersant. The dispersant may be any dispersant suitable for preventing the settling of any components in the solvent composition. Examples of suitable dispersants include, without limitation, sulfonated-formaldehyde-based dispersants, polycarboxylated ether dispersants, naphthalene sulfonate dispersants, the like, or any combinations thereof. The solvent composition may have any wt. % of the dispersant suitable for preventing the settling of any of the solvent composition components. In an embodiment, the solvent composition has between about 1 wt. % dispersant and about 10 wt. % dispersant, alternatively between about 2 wt. % dispersant and about 7 wt. % dispersant. In some embodiments, the dispersant may comprise about 3 wt. % of the solvent composition. With the benefit of this disclosure, one of ordinary skill in the art will be able to select an appropriate amount of dispersant for a chosen application.

In embodiments, the solvent composition may be prepared by mixing the MESO, aprotic solvent (i.e., DMSO), and the TS together prior to the addition of the cationic surfactant. Without being limited by theory, mixing the MESO, the aprotic solvent, and the TS prior to the addition of the cationic surfactant may improve mixability. In embodiments, the MESO, aprotic solvent, and the TS may be mixed together in any order. Moreover, once the MESO, aprotic solvent, the TS, and the cationic surfactant have been mixed together to create the solvent composition, the solvent composition may be stored until desired for use. In optional embodiments wherein the solvent composition also comprises a dispersant, the dispersant may be added to the solvent composition at any time during preparation of the solvent composition. The solvent composition may be prepared under any suitable conditions. In embodiments, the solvent composition may be prepared at ambient temperature and pressure.

In embodiments, the solvent composition may be diluted with the carrier fluid. In these embodiments, the carrier fluid may comprise any suitable carrier fluid that may dilute the solvent composition. In embodiments, the carrier fluid may comprise diesel fuel, biodiesel fuel, fuel oil, heavy aromatic naphtha, light sweet crude oil, crude oil, kerosene, vacuum gas oil, heavy vacuum gas oil (HVGO), light cycle oil, water, hydrogen, steam, the like, or any combinations thereof. Without being limited by theory, the carrier fluid may decrease the potency of the solvent composition, but not otherwise affect the efficacy. In embodiments, the solvent composition may be added to the carrier fluid in an amount between about 1 wt. % and about 99 wt. % of the carrier fluid, alternatively in an amount between about 1 wt. % and about 50 wt. % of the carrier fluid, alternatively between about 1 wt. % and about 20 wt. % of the carrier fluid, and further alternatively between about 1 wt. % and about 6 wt. % of the carrier fluid. In embodiments, the solvent composition may be added to the carrier fluid in an amount above 2-3 wt. % of the carrier fluid. With the benefit of this disclosure, one of ordinary skill in the art will be able to select an appropriate amount of solvent composition to carrier fluid for a chosen application.

Embodiments of the on-line decontamination process may comprise evaluating and monitoring thermal transmittance (U-Value) of the industrial equipment, particularly the heat exchanger, prior to injecting the decontamination composition. The U-Value may be important in determining how the industrial equipment is operating, for instance, whether the heat exchanger is operating at high efficiency or at low efficiency. For example, should a heat exchanger have a high U-Value between about 25 BTU/hr ft²° F. and about 40 BTU/hr ft²° F., the equipment may be operating at high efficiency. Alternatively, should a heat exchanger have a low U-Value between about 1 BTU/hr ft²° F. and about 20 BTU/hr ft²° F., the equipment may be operating at low efficiency. In embodiments, industrial equipment operating at low efficiency may confirm the need for an online cleaning. Additionally, the online decontamination process may comprise sampling filter material from the industrial equipment prior to injecting the decontamination composition. Sampling of the filter material may aid in determining the necessity of performing an on-line cleaning. For example, the sampling of filter material may be performed on a heat exchanger allowing an operator to determine the appropriate chemicals and decontamination process to implement. The presence of high levels of contaminant material in a filter may confirm the need for an on-line cleaning. Further, the operator may monitor other characteristics of the heat exchanger comprising, without limitation, differential pressure (dP), feed temperature, reactor temperature, or any combination thereof.

Embodiments of the on-line decontamination process may comprise injecting the decontamination composition into the industrial equipment at an injection point while the industrial equipment remains in operation. The injection point may be at any point between a feed tank of the industrial facility and the contaminated industrial equipment. In embodiments, the feed tank may be a vessel that houses the carrier fluid used in the decontamination composition. For example, the feed tank may house diesel that has been collected from other units such as, without limitation, a vacuum distillation column, an atmospheric distillation column, and/or a coker fractionator, that may be in operation at the industrial facility. In embodiments, the decontamination composition may be injected into the industrial equipment at about 1% to about 10% concentration of the total volumetric flow rate, or alternatively at about 1% to about 5% concentration of the total volumetric flow rate. In embodiments, the decontamination composition may be injected into the industrial equipment at about 3% concentration of the total volumetric flow rate. Injection may occur using any method known to one skilled in the art. In embodiments, the injection may occur by connecting a drum (approximately 55 gallons) of the solvent composition at the injection point using a series of hoses and pumping the decontamination composition through the industrial equipment via one or more pumps which may be driven by an onsite air supply.

During routine operation (i.e., operation without performing any on-line cleaning) the potentially contaminated industrial equipment may comprise a total volumetric flow rate or total unit throughput between about 15,000 barrels per day (BPD) and about 70,000 BPD, or alternatively between about 20,000 BPD and about 50,000 BPD. However, when implementing the on-line decontamination process the total volumetric flow rate may be reduced to any suitable amount. In embodiments, the total volumetric flow rate may be reduced to an amount between about 5,000 BPD and about 30,000 BPD, alternatively between about 7,000 BPD to about 15,000 BPD, or alternatively between about 8,000 BPD and about 10,000 BPD. In embodiments, the total volumetric flow rate may be reduced to about 9,000 BPD. Reduction of the total volumetric flow rate may allow for the preferred concentration of the decontamination composition to be achieved without having to provide an excessive and costly amount of the decontamination composition. In embodiments, the reduction of the total volumetric flow rate may comprise reducing the unit flow rate of any feed upstream of the contaminated industrial equipment such as, without limitation, a cracked feed, a straight run feed, a diesel product recycle feed, or any combinations thereof. Further, the unit flow rate of the various feeds may be manipulated via one or more suitable valves well known in the art, capable of fully or partially opening and closing.

In embodiments, any suitable amount of the decontamination composition may be injected into the industrial equipment over any suitable amount of time. In embodiments, the on-line decontamination process may comprise injecting between about 1 drum and about 5 drums of the solvent composition into the contaminated industrial equipment, or alternatively between about 2 drums and about 4 drums. In embodiments, the on-line decontamination process may comprise injecting about 3 drums of the solvent composition. In these embodiments, each drum of the solvent composition may be injected into the industrial equipment over a time period between about 1 minute and about 2 hours, alternatively between about 1 minute and about 30 minutes, or alternatively between about 5 minutes and about 20 minutes. In embodiments, each drum of the solvent composition may be injected over a time period of about 10 minutes. In some embodiments, the solvent composition may be injected at a rate between about 1 gallon per minute and about 5 gallons per minute. Further, in embodiments, moving the injection point closer to the contaminated equipment may allow the solvent composition to be injected faster. For example, moving the injection point downstream of a cracker feed utilized by the industrial facility may allow the solvent composition to be more quickly injected into a heat exchanger also utilized by the industrial facility. In embodiments, the number of drums required to reach a certain effective target concentration may be dictated by the rate at which an operator can pump the solvent composition into the industrial equipment at the reduced total volumetric flow rate.

In embodiments, the decontamination composition may be heated to increase its effectiveness on the contaminated industrial equipment. In embodiments, the decontamination composition may be heated to a temperature between about 100° F. and about 600° F., or alternatively between about 150° F. and about 450° F. In embodiments, the temperature at which to inject the decontamination composition into the contaminated industrial equipment may be dictated by the carrier fluid. For example, in embodiments in which the carrier fluid may be diesel fuel, the injection temperature may be heated to reach about 160° F., so as to keep the diesel fuel below its flash point, but in embodiments in which the carrier fluid is a heavier material, such as heavy vacuum gas oil (HVGO), the injection temperature may be heated to reach about 450° F. In some embodiments, the industrial equipment may utilize a recycled stream to provide heat to the decontamination composition. For example, embodiments in which the contaminated industrial equipment is a heat exchanger, the heat exchanger may utilize a diesel recycle stream which may provide heat to the decontamination composition during the on-line decontamination process.

Embodiments of the on-line decontamination process may comprise managing the contaminants or fouling material removed from the contaminated industrial equipment by the decontamination composition. In embodiments, the industrial equipment may comprise feed filters disposed downstream of any contaminated industrial equipment such that it may collect any removed contaminants. In embodiments, an operator may monitor the dP of the feed filters during the on-line decontamination process and replace the feed filters as needed.

To facilitate a better understanding of the present embodiments, the following examples of certain aspects of some embodiments are given. In no way should the following examples be read to limit, or define, the entire scope of the embodiments.

### Example 1

The decontamination composition was injected into a heat exchanger that feeds into a delayed coker unit. During normal operation this coker feed heat exchanger carries residual oil on its shell side and heavy coker gas oil (HCGO) on its tube side. Before carrying out the on-line decontamination process, the total unit feed rate for the delayed coker unit was 65,000 BPD and the U-Value was low. It was clear that the coker feed heat exchanger was experiencing severe asphaltenic plugging and significant efficiency loss because feed rates had to be slowed during normal operation. In this case, the plugging and efficiency loss was particularly problematic as this coker feed heat exchanger was incapable of being isolated to allow for conventional cleaning methods. Therefore, cleaning of this coker feed heat exchanger typically leads to a complete shutdown.

Testing of the on-line decontamination process began by sampling the unit feed and the filter material disposed within the contaminated coker feed heat exchanger. This helped to determine the type of chemistries that might be useful in cleaning the contaminants. Next, the charge feed for the coker feed heat exchanger was reduced to its lowest rate (9,000 BPD) and the decontamination composition was injected at 3% concentration of the total volumetric flow rate. After completion of the on-line decontamination process, the U-Value for the coker feed heat exchanger resulted in a 22% increase. This on-line decontamination process has become routine maintenance whenever U-Value begins to drop off, which may occur on average every 3-6 months.

### Example 2

The decontamination composition was injected into a heat exchanger that feeds into a diesel hydrotreater (DHT). During normal operation this DHT heat exchanger carries diesel with nitrogen and sulfur impurities to the DHT such that the impurities may be removed. Before carrying out the on-line decontamination process, the DHT heat exchanger was experiencing an increased dP on the tube side, lower feed preheat temperature, and significant loss in U-Value, all of which emphasize the need for cleaning and/or decontamination. Similar to Example 1, conventional cleaning methods for this DHT heat exchanger typically leads to complete shutdown as it too is incapable of being isolated.

Testing of the on-line decontamination process is described in the following timeline:

9:00 am—Baseline Values for the DHT heat exchanger: dP is 61 psig at 17,500 BPD. The injection point for the decontamination composition was located upstream of a cracked feed control valve between a diesel feed tank and the DHT heat exchanger. The operators reduced the total unit feed rate to 16,000 BPD by slightly closing valves of the various unit feeds (Cracked feed: 2,000 BPD; Straight run feed: 6,000 BPD; Diesel recycle feed: 8,000 BPD). The purpose for decreasing the unit feed rate was to increase the concentration of the decontamination composition being injected. Further, the diesel recycle feed was meant to provide heat to the DHT exchanger, making the decontamination composition as effective as possible.

9:48 am—Started injecting a 1st drum of the solvent composition.

10:10 am—Finished injecting the 1st drum of the solvent composition. Further, the location of the injection point was moved downstream of the cracked feed control valve between the diesel feed tank and the DHT heat exchanger. This allowed for the next drum of the solvent composition to be injected faster that the 1st drum.

10:16 am—Started injecting a 2nd drum of the solvent composition.

10:26 am—Finished injecting the 2nd drum of the solvent composition. Further, all the unit feed valves (i.e., the cracked feed valve, the straight run feed valve, and the diesel recycle feed valve) were closed before injecting a 3rd drum of the solvent composition.

10:30 am—Started injecting the 3rd drum of the solvent composition.

10:38 am—Finished injecting the 3rd drum of the solvent composition.

10:39 am—Opened all the unit feed valves to operate at 100%. This increased the feed filter dP from 0 to about 45 psi.

10:41 am—Closed all the unit feed valves to operate at about 50%. This reduced the feed filter dP to 34 psi at 16,000 BPD.

The results from the testing carried out in the timeline above are described in Table 1 below. In addition to the results in Table 1, the reactor temperature of the DHT experienced no change.

TABLE 1
On-line Decontamination Process Results

| | Before | After | |
|---|---|---|---|
| Parameter | Treatment | Treatment | Improvement |
| Unit Feed Rate (BPD) | 23,100 | 22,997 | — |
| Feed Valve Position | 100% | 71% | 29% |
| (% Opened) | | | |
| Feed Preheat | 94/202 | 125/257 | 31/55 |
| Temperature (° C./° F.) | | | |
| Exchanger U-Value | 17 | 29 | 13 |
| (BTU/hr ft²° F.) | | | |
| Exchanger Tube Side | 90 | 70 | 20 |
| dP (psi) | | | |

The results in Table 1 indicate an improvement in operation of the DHT heat exchanger that was achieved by implementing the on-line decontamination process. Further, the improvements were achieved without negatively effecting the DHT downstream of the DHT heat exchanger. For instance, because the reactor temperature of the DHT experienced no change, it can be concluded that the on-line decontamination process did not compromise the DHT or its components.

Although the present invention and its advantages have been described in detail, it should be understood that various changes, substitutions and alterations may be made herein without departing from the spirit and scope of the invention as defined by the appended claims.

What is claimed is:

1. A method for decontaminating industrial equipment in operation, wherein the industrial equipment comprises a total volumetric flowrate while operating, comprising:
(A) reducing the total volumetric flowrate;
(B) injecting a decontamination composition into the industrial equipment at an injection point while the industrial equipment remains in operation, wherein the decontamination composition comprises a solvent composition and a carrier fluid;
(C) allowing the decontamination composition to come in contact with any contaminant material disposed on the industrial equipment, wherein the contact removes the contaminant material from the industrial equipment; and
(D) managing the contaminant material removed from the industrial equipment.

2. The method of claim 1, wherein the total volumetric flow rate is reduced to an amount between about 5,000 BPD and about 30,000 BPD

3. The method of claim 1, wherein the industrial equipment comprises one or more heat exchangers, treating and/or blending units, or any combinations thereof.

4. The method of claim 3, wherein the treating and/or blending units comprise a hydrotreater, a coker unit, a crude distillation column, a vacuum distillation column, a fluidized catalytic cracker, a visbreaker, or any combinations thereof.

5. The method of claim 1, wherein the solvent composition comprises a mixture of three solvents and a cationic surfactant.

6. The method of claim 1, wherein the carrier fluid comprises diesel fuel, biodiesel fuel, naphtha, crude oil, kerosene, vacuum gas oil, light cycle oil, water, hydrogen, steam, or any combinations thereof.

7. The method of claim 1, wherein the carrier fluid is housed in a feed tank.

8. The method of claim 7, wherein the injection point is between the feed tank and the industrial equipment.

9. The method of claim 1, wherein the decontamination composition is injected into the industrial equipment at about 1% to about 10% concentration of the total volumetric flow rate.

10. The method of claim 1, wherein step (D) comprises monitoring differential pressure of feed filters disposed within the industrial equipment, wherein the differential pressure is altered by the amount of contaminant material removed from the industrial equipment.

11. The method of claim 1, wherein step (D) comprises replacing feed filter disposed within the industrial equipment based on its differential pressure.

12. A method for decontaminating industrial equipment in operation, wherein the industrial equipment comprises a total volumetric flowrate while operating, comprising:
(A) reducing the total volumetric flowrate;
(B) injecting a decontamination composition into the industrial equipment at an injection point while the industrial equipment remains in operation, wherein the decontamination composition comprises a solvent composition and a carrier fluid;
(C) allowing the decontamination composition to come in contact with any contaminant material disposed on the industrial equipment, wherein the contact removes the contaminant material from the industrial equipment;
(D) heating the decontamination composition via a recycled stream of the industrial equipment; and
(E) managing the contaminant material removed from the industrial equipment.

13. The method of claim 12, wherein the total volumetric flow rate is reduced to an amount between about 5,000 BPD and about 30,000 BPD

14. The method of claim 12, wherein the industrial equipment comprises one or more heat exchangers, treating and/or blending units, or any combinations thereof.

15. The method of claim 14, wherein the treating and/or blending units comprise a hydrotreater, a coker unit, or any combinations thereof.

16. The method of claim 12, wherein the solvent composition comprises a mixture of three solvents and a cationic surfactant.

17. The method of claim 12, wherein the carrier fluid comprises diesel fuel, biodiesel fuel, naphtha, crude oil, kerosene, vacuum gas oil, light cycle oil, water, hydrogen, steam, or any combinations thereof.

18. The method of claim 12, wherein the carrier fluid is housed in a feed tank.

19. The method of claim 18, wherein the injection point is between the feed tank and the industrial equipment.

20. The method of claim 12, wherein the recycled stream comprises diesel.
